(19) United States
(12) Patent Application Publication
(10) Pub. No.: US 2005/0174666 A1
(43) Pub. Date: Aug. 11, 2005

(54) Method and apparatus for recording and reproducing event signals

(75) Inventors: Emmanuel David Lucas Michael Frimout, Eindhoven (NL); Eric Frans Christiaan Josef Marie Tijssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/512,619

(22) PCT Filed: Apr. 4, 2003
(86) PCT No.: PCT/IB03/01446

(30) Foreign Application Priority Data
Apr. 29, 2002 (EP) 02076691.1

(51) Int. Cl. G11B 5/02

(52) U.S. Cl. 360/27

(57) ABSTRACT

A method for recording and reproducing event signals supplied at particular times from at least one source as well as preset data selectively input by a user which data establishes an event signal to be recorded and the time of recording that event signal, wherein audio and video signals are to be recorded on or reproduced from at least one record medium dependent on at least said preset data, said method comprising the steps of: -selectively producing said preset data to select source, time and duration of event signals to be recorded; -storing said preset data; and -providing management data each related to the recording and reproducing operation of a specific record medium; is characterized by -storing at least said management data on a storage medium different from said at least one record medium.

The invention relates to a method and to an apparatus for recording an reproducing event signals supplied at particular times from at least one source as well as preset data selectively input by a user which data establishes and event signal to be recorded and the time of recording that event signal. The method and the apparatus of the invention cooperate with at least one record medium on which event signals, including audio and/or video signals, are to be recorded or reproduced therefrom, dependent on at least said preset data. Firstly, said preset data are selectively produced to select source, time and duration of event signals to be recorded, then these preset data are stored. Management data are provided, each related to the recording and reproducing operation of a specific record medium.

Such method and apparatus is disclosed in U.S. Pat. No. 5,379,153 in relation to a video tape recorder and video tapes. The management data are recorded on the video tape and represent management information on the particular video cassette that is mounted into the video tape recorder. For example, it comprises a block representing details concerning the recording format convention and the history of the video tape but do not represent details concerning each event that has been or will be recorded.

In recent years, media on which data may be stored in digital form became popular. In particular, the digital versatile disc (DVD) has proven to be an effective record medium for video images. The first generation of DVD video recorders can be programmed with a number of timer recordings. When a timer expires, the system will check if a recordable disc is present and initiate the programmed recording if possible. Programmed timers are either for a single recording event, or for a daily re-occurring recording event. Daily programmed recordings will be performed on every day of the week. The recording will be done on any DVD that happens to be present in the recorder when the timer expires. Problems may occur with the current way of working, for example that daily programmed recordings will execute unconditionally on any recordable disc that happens to be present. This will result in a content mix on a single disc. Further, there is no intermediate approach between a single programmed recording and a daily programmed recording. A typical case of use would be that the user is present most of the time to watch his favorite program life, but occasionally he knows that he would like to record the programs when he expects to be late. Programming a single recording to handle the above use-case involves too many actions.

Consequently, the above outlined concept of U.S. Pat. No. 5,379,153 for video tapes and video tape recorders should be transferred to systems using discs to link a specific re-occurring programmed timer to a specific disc. When inserting a particular disc, this will enable a timer, or present data, for a specific event. The event can be specified in the conventional way with date, channel, time, VPS, or in any other way referencing meta data like news, star track and so on. As such, the disc can be used as a token, programming the recording of a particular program when it is inserted.

While in the concept of U.S. Pat. No. 5,379,153 the management information is exclusively recorded on the video tape, this concept cannot be extended to applications for which discs like DVD qualify.

It is therefore an object of the invention to modify the above method in such a way that it is more flexible with respect to future applications.

This object is solved by a method of claim 1 or 4 or by an apparatus of claim 7 or 11. Preferred embodiments are subject-matter of respective subclaims.

According to the invention, the management data are stored on a storage medium or in a storage means different from said at least one record medium. Normally, they are stored in the recorder's NVRAM (Non Volatile RAM), as it is currently the case for video recorders or the first generation DVD recorders. Programmed timers or other present data in the NVRAM are only activated when the corresponding disc is inserted. Only activated programmed timers will execute and initiate a recording. When the disc is ejected, all related programmed timers are cancelled.

It is preferred that also said preset data is stored on said storage medium or in said storage means.

In a most preferred embodiment, a specific record medium is selected from a plurality of record media based on the related management data.

The concept of this most preferred embodiment can also be applied when management data are stored on the record medium itself. Then, the related management data of each of said record media should be uploaded into a temporary storage medium which suitably is part of the recorder or even of a changer means for the record medium; and one of said recording media may be selected for recording or reproducing operation based on the management data stored in said temporary storage medium.

The invention will be described in further details with reference to the accompanying drawing.

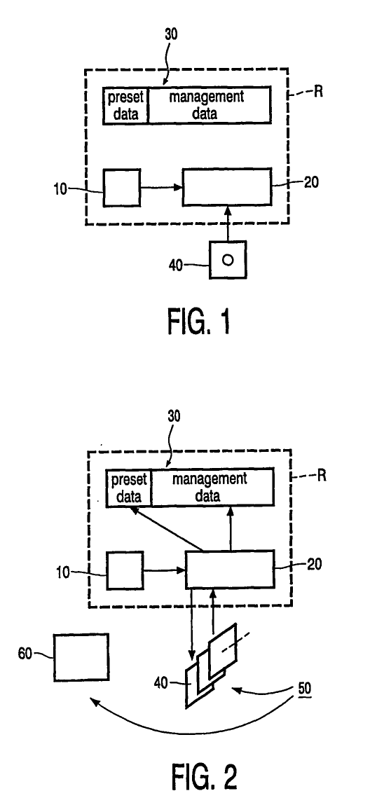

FIG. 1 is a block diagram showing main components of an apparatus according to the invention; and

FIG. 2 is a modification thereof.

FIG. 1 shows a block diagram of an apparatus in form of a recorder unit R according to the invention. A data input unit 10 is provided which selectively produces preset data to select source, time and duration of event signals supplied along with requirements from a user. Under control of a control unit 20, the preset data are stored in a storage means 30 which may be the NVRAM of the recorder. When a specific disc is inserted into the recorder, the disc is identified, and only those preset data in NVRAM are activated, which are associated to the disc, based on management data related to the disc. Only activated preset data will execute and initiate a recording.

FIG. 2 is an extension of the block diagram of FIG. 1, wherein a plurality of discs is loaded into a multi-disc changer 50, related to desired re-occurring recordings. The total set of recordable discs will enable a number of preset data for a number of event. Whenever preset data is executed, the system will switch to the corresponding disc and initiate a recording. As such, all recordings, for example of the same type, will be collected on the same disc.

The stored information for particular events can be extended with additional options that specify how the recording must be made. Relevant options could be to start recording at the beginning of the disc or at the last recorded position, or to restart at the beginning of the disc or to stop, when the disc is full.

The features disclosed in the foregoing description, in the claims and/or in the accompanying drawings may, both separately and in any combination thereof, be material for realising the invention in diverse forms thereof.

1. A method for recording and reproducing event signals supplied at particular times from at least one source as well as preset data selectively input by a user which data establishes an event signal including as audio and/or video signals, to be recorded and the time of recording that event signal, wherein said audio and video signals are to be recorded on or reproduced from at least one record medium dependent on at least said preset data, said method comprising the steps of:
selectively producing said preset data to select source, time and duration of event signals to be recorded;
storing said preset data; and
providing management data each related to the recording and reproducing operation of a specific record medium;
characterized by
storing at least said management data on a storage medium different from said at least one record medium.

2. The method of claim 1, characterized in that said preset data is stored on said storage medium.

3. The method of claim 1, characterized in that a specific record medium is selected from a plurality of record media based on the related management data.

4. A method for recording and reproducing event signals supplied at particular times from at least one source as well as preset data selectively input by a user which data establishes an event signal including audio and/or video signals to be recorded and the time of recording that event signal, wherein said audio and video signals are to be recorded on or reproduced from at least one record medium dependent on at least said preset data, said method comprising the steps of:
selectively producing said preset data to select source, time and duration of event signals to be recorded;
storing said preset data; and
providing management data each related to the recording and reproducing operation of a specific record medium; and
storing on the specific record medium at least the management date related thereto,
characterized by
providing a plurality of first record media to be accessed for recording or reproducing operation;
uploading the related management data of each of said record media into a temporary storage medium; and
selecting one of said record media for recording or reproducing operation based on the management data stored in said temporary storage medium.

5. The method of claim 1, characterized in that said record medium is a medium on which data may be stored in digital form.

6. The method of claim 5, characterized in that said record medium is a re-writable compact disc or a digital versatile disc (DVD).

7. An apparatus for recording an reproducing event signals supplied at particular times from at least one source as well as preset data selectively input by a user which data establishes an event signal including audio and/or video to be recorded and the time of recording that event signal, comprising:
data input means for selectively producing said preset data to select source, time and duration of event signals to be recorded;
storage means operatively coupled to said data input means for storing said preset data produced by said data input means;
means for recording and reproducing said audio and video signals on at least one record medium dependent on at least said preset data; and
means for providing management data each related to the recording and reproducing operation of a specific record medium;
characterized by
storage means for storing at least said management data, where said storage means is different from said at least one record medium.

8. The apparatus of claim 7, characterized in that said preset data is stored in said storage means.

9. The apparatus of claim 7, characterized by
control means for selecting a specific record medium from a plurality of record media based on the related management data.

10. An apparatus for recording an reproducing event signals supplied at particular times from at least one source as well as preset data selectively input by a user which data establishes an event signal including audio and/or video signals to be recorded and the time of recording that event signal, comprising:
data input means for selectively producing said preset data to select source, time and duration of event signals to be recorded;
storage means operatively coupled to said data input means for storing said preset data produced by said data input means;
means for recording and reproducing said audio and video signals on at least one record medium dependent on at least said preset data; and
means for providing management data each related to the recording and reproducing operation of a specific record medium, where at least the management data are stored on the specific record medium related thereto;
characterized by
means for providing a plurality of first record media to be accessed for recording or reproducing operation;
means for uploading the related management data of each of said record media into a temporary storage means;
control means for selecting one of said record media for recording or reproducing operation based on the management data stored in said temporary storage means.

11. The apparatus of claim 7, characterized in that said record medium is a medium on which data may be stored in digital form.

12. The apparatus of claim 11, characterized in that said record medium is a re-writable compact disc or a digital versatile disc (DVD).

13. The apparatus of claim 7, characterized in that said record media are accommodated in a multi-disc changer.
